(19) United States
(12) Patent Application Publication
(10) Pub. No.: US 2026/0327739 A1
(43) Pub. Date: Oct. 22, 2026

(54) Compositions and Methods for Solvent Extraction

(71) Applicant: Locus Solutions IPCo, LLC, Solon, OH (US)

(72) Inventor: Gabriela KNESEL, Solon, OH (US)

(21) Appl. No.: 19/109,018

(22) PCT Filed: Jul. 27, 2023
(86) PCT No.: PCT/US2023/071119

§ 371 Date: Mar. 5, 2025

Related U.S. Application Data
(60) Provisional application No. 63/405,548, filed on Sep. 12, 2022.

(51) Int. Cl. C22B 3/26; C22B 3/18

(52) U.S. Cl. CPC C22B 3/41; C22B 3/18

(57) ABSTRACT

The subject invention provides safe, environmentally-friendly compositions and efficient methods for solvent extraction. More specifically, the subject invention provides compositions derived from microorganisms for solvent extraction, which can be used for increasing the rate of solvent extraction and/or the amount of extracted metals, minerals, elements, or other substances of interest.

### CROSS-REFERENCE TO RELATED APPLICATION

This application claims priority to U.S. Provisional Patent Application No. 63/405,548, filed Sep. 12, 2022, which is incorporated herein by reference in its entirety.

### BACKGROUND OF THE INVENTION

Low-grade or low-value deposits can be mined from the earth using various mining and quarrying practices. During mining, solvent extractants can be added to separate certain cations or anions and sequester them from an aqueous phase into an organic phase, thus separating them from other unwanted ionic species. Currently, cheating agents are used in connection with leaching or lixiviation methods to progressively concentrate a given element, ore, or mineral from a dilute solution containing numerous other ions through a series of chelating and elution stages.

Presently, only a few commercial solvents are widely used—the secondary, tertiary, and quaternary amines and some alkyl phosphoric acids. The amines act by forming an organic-soluble salt with the anions, whereas the alkyl phosphoric acids react with cations.

There are roughly three general groups of solvent extractants in use today. The extractants used for oxide copper are oximes and modified aldoximes, typically ACORGA® (Solvay) and LIX® (BASF) products. Extractants used for uranium processing are tertiary amines exemplified by the Alamine® reagents made by BASF. The third general type of extractants are phosphate-derived, such as Di-(2-Ethyl Hexyl) phosphoric acid (D2EHPA), trioctylphosphine oxide (TOPO), and tributyl phosphate (TBP), which are widely commercially available. This third group makes up the largest volume of extractants and are so widely available that they are considered generic. Also within that general category are phosphine extractants, such as Solvay's CYANEX® and Clariant's Hostarex™. This group of chemicals is used for the separation of rare earth oxides, cobalt, platinum group metals, and others. They are used in relatively small quantities and are the most expensive.

Solvent extractants are used primarily in the hydrometallurgical treatment of copper and uranium ores. Usage in copper mining, in which solvent extraction is particularly attractive for lower-grade ores and workover of tailings material. The hydrometallurgical extraction of copper is particularly attractive today because it is recognized as the most likely technology to yield low operating costs.

Therefore, novel, improved compositions and methods are needed for solvent extraction.

### BRIEF SUMMARY OF THE INVENTION

The subject invention relates generally to solvent extraction compositions and methods of using said compositions. More specifically, the subject invention provides environmentally-friendly solvent extraction compositions and methods for solvent extraction, such as, for example, during mining and beneficiation processes. In certain embodiments, existing methods can incorporate the subject compositions and methods.

Advantageously, the compositions and methods of the subject invention increase the efficiency of solvent extraction and can decrease the chemical usage, including chemical surfactant or organic solvent usage, required for solvent extraction. Accordingly, the subject invention can be useful for reducing the time needed for mining and the ensuing beneficiation processes.

In certain embodiments, the subject invention provides compositions comprising components that are derived from microorganisms. In certain embodiments, the composition comprises a microbial biosurfactant. In certain embodiments, the composition comprises one or more biosurfactants, and, optionally, other compounds, such as, for example, water; chemical surfactants; organic solvents; oximes; modified aldoximes; amines, including, for example, second and tertiary amines; phosphates; phosphines; chelating agents, including, for example, EDTA; acids; diluents; polymers; or any combination thereof.

In certain embodiments, the biosurfactant of the composition is utilized in crude form. The crude form can comprise, in addition to the biosurfactant, the fermentation broth in which a biosurfactant-producing microorganism was cultivated, residual microbial cell matter or live or inactive microbial cells, residual nutrients, and/or other microbial growth by-products.

In some embodiments, the biosurfactant is utilized after being extracted from a fermentation broth and, optionally, purified.

The biosurfactant according to the subject invention can be a glycolipid (e.g., sophorolipid, rhamnolipid, cellobiose lipid, mannosylerythritol lipid or trehalose lipid), lipopeptide (e.g., surfactin, iturin, fengycin, arthrofactin, or lichenysin), flavolipid, phospholipid (e.g., cardiolipins), fatty acid ester compound, fatty acid ether compound, and/or high molecular weight polymers such as lipoproteins, lipopolysaccharide-protein complexes, and polysaccharide-protein-fatty acid complexes.

In certain specific embodiments, the biosurfactant is a sophorolipid (SLP), including linear SLP, lactonic SLP, acetylated SLP, de-acetylated SLP, salt-form SLP, esterified SLP derivatives, amino acid-SLP conjugates, and other SLP derivatives or isomers that are produced via fermentation and/or are produced or modified synthetically. In preferred embodiments, the SLP is a linear SLP or a derivatized linear SLP.

In certain embodiments, the subject invention provides a method for solvent extraction, wherein the method comprises the following steps:
a) contacting a solvent extraction composition comprising a biosurfactant with a liquid containing an element, metal, mineral, or other substance of interest; and
b) recovering the element, metal, mineral, or other substance of interest from the solvent extraction composition.

In certain embodiments, the recovery of the element, ore, mineral, or other compound of interest can be performed using centrifugation, filtering, using gravitational principles (e.g., settling), or any combination thereof.

In some embodiments, the method enhances or increases the rate of recovery of an element, metal, mineral, or other substance and/or the amount of an element, ore, mineral, or other substance recovered.

In some embodiments, the method comprises contacting a solvent extraction composition comprising a biosurfactant and, optionally, other components to a liquid containing a metal, element, mineral or other substance of interest. In certain embodiments, the solvent extraction composition can be applied to the liquid for a period of time and/or until a distinct volume of the composition has been applied. The step can be repeated as many times as necessary to achieve a rate of recovery of an element, metal, mineral, or other substance or until a desired amount of an element, metal, mineral, or other substance is recovered.

In certain embodiments, the solvent extraction composition according to the subject invention is effective due to improving phase transfer times, reducing crud formation, and/or protecting against extractant losses due to nitration and oxidation.

In certain embodiments, the methods of the subject invention result in at least a 25% increase in the recovery of elements, minerals, metals, or other substances of interest, preferably at least a 50% increase, after one treatment. In certain embodiments, the liquid composition can be treated multiple times to further increase the amount of recovered elements, metals, minerals, or other substances of interest.

Advantageously, in certain embodiments, the solvent extraction composition according to the subject invention can be effective at the extraction of low-value elements, minerals, metals, or other substances of interest. Furthermore, the methods of the subject invention do not require complicated equipment or high energy consumption, and production of the composition can be performed on site, for example, at a mine or at an industrial site.

### DETAILED DESCRIPTION

The subject invention relates generally to the recovery of purified and/or concentrated elements, minerals, metals, or other substances of interest. More specifically, the subject invention provides environmentally-friendly compositions and methods for solvent extraction, such as, for example, concentrating and/or purifying elements, minerals, metals, or other substances of interest from a liquid that is produced at mining sites or derived from or for industrial activities. Accordingly, the subject invention is useful for improving the efficiency and efficacy of methods of solvent extraction. Advantageously, the compositions and methods of the subject invention increase the recovery of elements, minerals, metals, or other substances of interest using safe, environmentally-friendly compositions.

### Selected Definitions

As used herein, “applying” a composition or product refers to contacting it with a target or site such that the composition or product can have an effect on that target or site. The effect can be due to, for example, microbial growth and/or the action of a biosurfactant or other microbial growth by-product.

As used herein, a “biofilm” is a complex aggregate of microorganisms, such as bacteria, yeast, or fungi, wherein the cells adhere to each other and/or to a surface using an extracellular matrix. The cells in biofilms are physiologically distinct from planktonic cells of the same organism, which are single cells that can float or swim in liquid medium.

As used herein, an “isolated” or “purified” nucleic acid molecule, polynucleotide, polypeptide, protein or organic compound such as a small molecule (e.g., those described below), is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state. An isolated microbial strain means that the strain is removed from the environment in which it exists in nature. Thus, the isolated strain may exist as, for example, a biologically pure culture, or as spores (or other forms of the strain) in association with a carrier.

In certain embodiments, purified compounds are at least 60% by weight the compound of interest. Preferably, the preparation is at least 75%, more preferably at least 90%, and most preferably at least 98%, by weight the compound of interest. For example, a purified compound is one that is at least 80%, 85%, 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

A “metabolite” refers to any substance produced by metabolism or a substance necessary for taking part in a particular metabolic process. A metabolite can be an organic compound that is a starting material, an intermediate in, or an end product of metabolism. Examples of metabolites include, but are not limited to, enzymes, acids, solvents, alcohols, proteins, vitamins, minerals, microelements, amino 5 acids, biopolymers and biosurfactants.

Ranges provided herein are understood to be shorthand for all of the values within the range. For example, a range of 1 to 20 is understood to include any number, combination of numbers, or sub-range from the group consisting 1, 2, 3, 4, 5, 6, 7, 8, 9, 10, 11, 12, 13, 14, 15, 16, 17, 18, 19 and 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein a “reduction” means a negative alteration, and an “increase” means a positive alteration, wherein the negative or positive alteration is at least 0.001%, 0.01%, 0.1%, 0.5%, 1%, 5%, 10%, 15%, 20%, 25%, 30%, 35%, 40%, 45%, 50%, 55%, 60%, 65%, 70%, 75%, 80%, 85%, 90%, 95% or 100%.

As used herein, “surfactant” means a compound that lowers the surface tension (or interfacial tension) between two liquids or between a liquid and a solid. Surfactants act as, e.g., detergents, wetting agents, emulsifiers, foaming agents, and/or dispersants. A “biosurfactant” is a surface-active substance produced by a living cell and/or using naturally-derived substrates.

Biosurfactants are a structurally diverse group of surface-active substances consisting of two parts: a polar (hydrophilic) moiety and non-polar (hydrophobic) group. Due to their amphiphilic structure, biosurfactants can, for example, increase the surface area of hydrophobic water-insoluble substances, increase the water bioavailability of such substances, and change the properties of bacterial cell surfaces. Biosurfactants can also reduce the interfacial tension between water and oil and, therefore, lower the hydrostatic pressure required to move entrapped liquid to overcome the capillary effect. Biosurfactants accumulate at interfaces, thus reducing interfacial tension and leading to the formation of aggregated micellar structures in solution. The formation of micelles provides a physical mechanism to mobilize, for example, oil in a moving aqueous phase.

The ability of biosurfactants to reduce the surface tension also permits their use as antibacterial, antifungal, and hemolytic agents to, for example, control pests and/or microbial growth.

Typically, the hydrophilic group of a biosurfactant is a sugar (e.g., a mono-, di-, or polysaccharide) or a peptide, while the hydrophobic group is typically a fatty acid. Thus, there are countless potential variations of biosurfactant molecules based on, for example, type of sugar, number of sugars, size of peptides, which amino acids are present in the peptides, fatty acid length, saturation of fatty acids, additional acetylation, additional functional groups, esterification, polarity and charge of the molecule.

These variations lead to a group of molecules comprising a wide variety of classes, including, for example, glycolipids (e.g., sophorolipids, rhamnolipids, cellobiose lipids, mannosylerythritol lipids and trehalose lipids), lipopeptides (e.g., surfactin, iturin, fengycin, arthrofactin and lichenysin), flavolipids, phospholipids (e.g., cardiolipins), fatty acid ester compounds, and high molecular weight polymers such as lipoproteins, lipopolysaccharide-protein complexes, and polysaccharide-protein-fatty acid complexes. Each type of biosurfactant within each class can further comprise subtypes having further modified structures.

Like chemical surfactants, each biosurfactant molecule has its own HLB value depending on its structure; however, unlike production of chemical surfactants, which results in a single molecule with a single HLB value or range, one cycle of biosurfactant production typically results in a mixture of biosurfactant molecules (e.g., subtypes and isomers thereof).

The phrases “biosurfactant” and “biosurfactant molecule” include all forms, analogs, orthologs, isomers, and natural and/or anthropogenic modifications of any biosurfactant class (e.g., glycolipid) and/or subtype thereof (e.g., sophorolipid).

As used herein, the term “sophorolipid,” “sophorolipid molecule,” “SLP” or “SLP molecule” includes all forms, and isomers thereof, of SLP molecules, including, for example, acidic (linear) SLP (ASL) and lactonic SLP (LSL). Further included are mono-acetylated SLP, di-acetylated SLP, esterified SLP, SLP with varying hydrophobic chain lengths, cationic and/or anionic SLP with fatty acid-amino acid complexes attached, esterified SLP, SLP-metal complexes, SLP-salt derivatives (e.g., a sodium salt of a linear SLP), and other, including those that are and/or are not described within in this disclosure.

In certain embodiments, the glycolipid biosurfactant is a sophorolipid (SLP). Sophorolipids are glycolipid biosurfactants produced by, for example, various yeasts of the Starmerella clade when cultivated in the presence of a hydrocarbon-based source of one or more fatty acids. SLP typically consist of a disaccharide sophorose linked to long chain hydroxy fatty acids. They can comprise a partially acetylated 2-O-β-D-glucopyranosyl-D-glucopyranose unit attached β-glycosidically to 17-L-hydroxyoctadecanoic or 17-L-hydroxy-49-octadecenoic acid. The hydroxy fatty acid is generally 16 or 18 carbon atoms, and may contain one or more unsaturated bonds. Furthermore, the sophorose residue can be acetylated on the 6- and/or 6′-position(s). The fatty acid carboxyl group can be free (acidic or linear form (General Formula 2)) or internally esterified at the 4″-position (lactonic form (General Formula 1)). S. bombicola produces a specific enzyme, called S. bombicola lactone esterase, which catalyzes the esterification of linear SLP to produce lactonic SLP.

In preferred embodiments, the SLP according to the subject invention are represented by General Formula (1) and/or General Formula (2), and are obtained as a collection of 30 or more types of structural homologs:

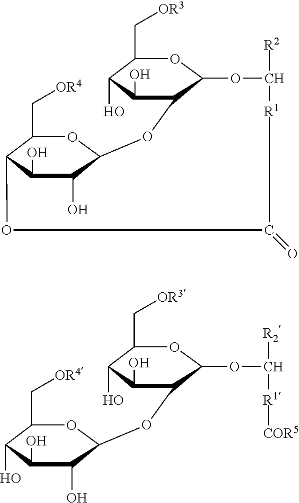

where R¹ and R^{1′} independently represent saturated hydrocarbon chains or single or multiple, in particular single, unsaturated hydrocarbon chains having 8 to 20, in particular 12 to 18 carbon atoms, more preferably 14 to 18 carbon atoms, which can be linear or branched and can comprise one or more hydroxy groups, R² and R^{2′} independently represent a hydrogen atom or a saturated alkyl functional group or a single or multiple, in particular single, unsaturated alkyl functional group having 1 to 9 carbon atoms, more preferably 1 to 4 carbon atoms, which can be linear or branched and can comprise one or more hydroxy groups, and R³, R^{3′}, R⁴ and R^{4′} independently represent a hydrogen atom or —COCH₃.

The composition utilized according to the subject methods can comprises more than one form of SLP, including linear SLP and lactonic SLP. The SLP can be non-acetylated, mono-acetylated and/or di-acetylated SLP.

In certain specific embodiments, the composition comprises SLP according to General Formula (1) (linear SLP) wherein R¹ and/or R² are an acetyl group, and wherein R³ is derived from a stearic, oleic and/or linoleic fatty acid.

SLP are typically produced by yeasts, such as Starmerella spp. yeasts and/or Candida spp. yeasts, e.g., Starmerella (Candida) bombicola, Candida apicola, Candida batistae, Candida floricola, Candida riodocensis, Candida stellate and/or Candida kuoi. SLP have environmental compatibility, high biodegradability, low toxicity, high selectivity and specific activity in a broad range of temperature, pH and salinity conditions. Additionally, in some embodiments, SLP can be advantageous due to their small micelle size, which can help facilitate the movement of the micelle, and compounds enclosed therein, through nanoscale pores and spaces. In certain embodiments, the micelle size of a SLP is less than 100 nm, less than 50 nm, less than 20 nm, less than 15 nm, less than 10 nm, or less than 5 nm.

In certain embodiments, the glycolipid is a rhamnolipid. Rhamnolipids comprise a glycosyl head group (i.e., a rhamnose) moiety, and a 3-(hydroxyalkanoyloxy)alkanoic acid (HAA) fatty acid tail, such as, e.g., 3-hydroxydecanoic acid. Two main subtypes of rhamnolipids exist, mono- and di-rhamnolipids, which comprise one or two rhamnose moieties, respectively. The HAA moiety can vary in length and degree of branching, depending on, for example, the growth medium and the environmental conditions. The highest accumulation of rhamnolipids (RLP) has been shown by submerged cultivation of Pseudomonas spp., such as P. aeruginosa.

Rhamnolipids according to the subject invention can have the following structure, according to General Formula (3):

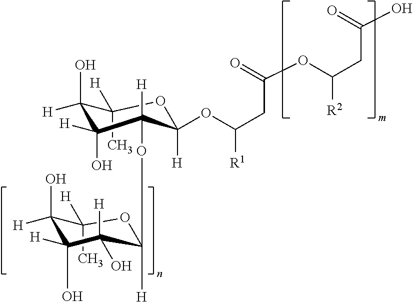

wherein m is 2, 1 or 0,
n is 1 or 0,
R¹ and R² are, independently of one another, the same or a different organic functional group having 2 to 24, preferably 5 to 13 carbon atoms, in particular a substituted or unsubstituted, branched or unbranched alkyl functional group, which can also be unsaturated,
wherein the alkyl functional group is a linear saturated alkyl functional group having 8 to 12 carbon atoms, or is a nonyl or a decyl functional group or a mixture thereof.

Salts of these compounds are also included according to the invention. In the present invention, the term “di-rhamnolipid” is understood to mean compounds of the above formula or the salts thereof in which n is 1. Accordingly, “mono-rhamnolipid” is understood in the present invention to mean compounds of the general formula or the salts thereof in which n is 0. In certain specific embodiments, the composition comprises a mixture of mono- and di-rhamnolipids.

As used herein, “solvent extraction” refers to the process by which minerals, elements, metals, or other substances of interest are purified and/or concentrated from deposits or ores or during a beneficiation process.

As used herein, “beneficiation” refers to the process by which gangue materials are removed from the substance of interest (e.g., element, compound, mineral).

As used herein, “leaching” refers to the process by which metal is extracted from ore by aqueous solutions including by, for example, ammonia leaching, alkali leaching, acid leaching, cyanidation (i.e., cyanide leaching), or thiosulfate leaching.

As used herein, “crud” refers to the buildup of impurities, metals, ores, elements, and/or minerals on the equipment used in the solvent extraction process, such as, for example, a settler.

As used herein, the term “metal” refers to any element of the periodic table (or species thereof) with oxidation states higher than 0 and associated with the groups chosen from main metals, transition metals, alkali metals, alkaline earth metals, metalloids, rare earth metals, lanthanides, actinides, semi-metals, and semi-conductors.

As used herein, “ore” refers to a naturally occurring solid material from which a valuable substance, mineral and/or metal can be profitably extracted. Ores are often mined from ore deposits, which comprise ore minerals containing the valuable substance. “Gangue” minerals are minerals that occur in the deposit but do not contain the valuable substance. Examples of ore deposits include hydrothermal deposits, magmatic deposits, laterite deposits, volcanogenic deposits, metamorphically reworked deposits, carbonatite-alkaline igneous related deposits, placer ore deposits, residual ore deposits, sedimentary deposits, sedimentary hydrothermal deposits and astrobleme-related deposits. Ores, as defined herein, however, can also include ore concentrates or tailings.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially of” the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references cited herein are hereby incorporated by reference in their entirety.

### Solvent Extraction Compositions

In certain embodiments, the subject invention provides compositions comprising components that are derived from microorganisms. In certain embodiments, the composition comprises a microbial biosurfactant. In certain embodiments, the composition comprises one or more biosurfactants, and, optionally, other compounds, such as, for example, water, chemical surfactants, extractants, acids, organic solvents, oximes, modified aldoximes, amines (e.g., second and tertiary amines), phosphates, phosphines, chelating agents (e.g., EDTA), diluents, polymers, or any combination thereof.

In certain embodiments, the chemical surfactant of the solvent extraction composition is a detergent, wetting agent, emulsifier, foaming agent, and/or dispersant. In certain embodiments, the chemical surfactant is an ionic or non-ionic surfactant.

In certain embodiments, the organic solvent is ethyl acetate (EtOAc), methanol (MeOH), kerosene, toluene, dichloromethane, diethyl ether, N,N-dimethylformamide (DMF), Di-2-ethylhexylphosphoric acid (D2EHPA), Tributylphosphate (TBP), 1-phenyl-3-heptyl-1,3-propanedione, 1-phenyl-4-ethyl-1,3-octanedione, 1-(4′-dodecyl)phenyl-3-tert-butyl-1,3-propanedione, LIX-63, LIX-64, LIX-64N, chloroform, dichloromethane, 1,2-dichloroethane, or any combination thereof.

In certain embodiments, the polymers can include natural or synthetic polymers, water soluble polymers, cationic polymers, anionic polymers, or non-ionic polymers. The polymers can be, for example, anionic polyacrylamide, modified polyacrylamide, nonionic polyacrylamide, starch, guar gum, Moringa oleifera seed extract, Strychnos potatorum seed extract, gelatin (e.g., isinglass), alginate (e.g., sodium alginate), or polymeric ferric sulfate.

In certain embodiments, the acid is hydrochloric acid, ascorbic acid, oxalic acid, citric acid, sulfuric acid, or any combination thereof.

In certain embodiments, the oxime or modified aldoxime is dimethylglyoxime, salicylaldoxime, 5-nonylsalicylaldoxime, 5-nonyl-2-hydroxyacetophenone oxime, 5-dodecylsalicylaldoxime, an amidoxime (e.g., polyacrylamidoxim), or any combination thereof.

In certain embodiments, chelating agents can be, but are not limited to, ethylenediaminetetraacetic acid (EDTA), nitrilotriacetic acid (NTA), nitrilotris(methylene)triphosphonic acid (NTTA), trimethylenedinitrilotetraacetic acid (TMDTA), L-5-glutamyl-L-cysteinylglycine (GCG), calcium trisodium diethylenetriaminepentaacetic acid, sodium nitrilotriacetic acid, a phosphonate, succimer (DMSA), diethylenetriaminepentaacetate (DTPA), N-acetylcysteine, n-hydroxyethylethylenediaminetriacetic acid (HEDTA), organic acids with more than one coordination group (e.g., rubeanic acid), STPP (sodiumtripolyphosphate, Na₅P₃O₁₀), trisodium phosphate (TSP), water, carbohydrates, organic acids with more than one coordination group (e.g., citric acid), lipids, steroids, amino acids or related compounds (e.g., glutathione), peptides, phosphates, nucleotides, tetrapyrrols, ferrioxamines, ionophores, orphenolics, sodium citrate, sodium gluconate, ethylenediamine disuccinic acid (EDDS), iminodisuccinic acid (IDS), L-glutamic acid diacetic Acid (GLDA), GLDA-Na₄, methyl glycindiacetic acid (MGDA), polyaspartic acid (PASA), hemoglobin, chlorophyll, lipophilic β-diketone, and (14,16)-hentriacontanedione, ethylenediamine-N,N′-diglutaric acid (EDDG), ethylenediamine-N,N′-dimalonic acid (EDDM), 3-hydroxy-2,2-iminodisuccinic acid (HIDS), 2-hydroxyethyliminodiacetic acid (HEIDA), pyridine-2,6-dicarboxylic acid (PDA), trimethyl glycine (TMG), Tiron, or any combination thereof.

In certain embodiments, the diluents can be aromatic or aliphatic diluents, such as, for example, n-heptane, methylcyclohexane, toluene, decalin, n-octanol, and isopropyl ether.

In certain embodiments, the solvent extraction composition comprises a microbe-based product comprising a biosurfactant utilized in crude form. The crude form can comprise, in addition to the biosurfactant, fermentation broth in which a biosurfactant-producing microorganism was cultivated, residual microbial cell matter or live or inactive microbial cells, residual nutrients, and/or other microbial growth by-products. The product may be, for example, at least, by weight, 1%, 5%, 10%, 25%, 50%, 75%, or 100% broth. The amount of biomass in the product, by weight, may be, for example, anywhere from 0% to 100% inclusive of all percentages therebetween.

In some embodiments, the biosurfactant is utilized after being extracted from a fermentation broth and, optionally, purified.

The biosurfactant according to the subject invention can be a glycolipid (e.g., sophorolipids, rhamnolipids, cellobiose lipids, mannosylerythritol lipids and trehalose lipids), lipopeptide (e.g., surfactin, iturin, fengycin, arthrofactin and lichenysin), flavolipid, phospholipid (e.g., cardiolipins), fatty acid ester compound, fatty acid ether compound, and/or high molecular weight polymers such as lipoproteins, lipopolysaccharide-protein complexes, and polysaccharide-protein-fatty acid complexes.

In certain specific embodiments, the biosurfactant is a sophorolipid (SLP), including linear SLP, lactonic SLP, acetylated SLP, de-acetylated SLP, salt-form SLP derivatives, esterified SLP derivatives, amino acid-SLP conjugates, and other SLP derivatives or isomers that exist in nature and/or are produced synthetically. In preferred embodiments, the SLP is a linear SLP or a derivatized linear SLP. In certain embodiments, the subject compositions can comprise lactonic and linear SLP, with at least about 50%, about 55%, about 60%, about 65%, about 70%, about 75%, about 80%, about 85%, about 90%, or about 95% of the SLP comprising linear forms, and the remainder comprising lactonic forms.

In some embodiments, the biosurfactant can be included in the composition at 0.01 to 99.9%, 0.1 to 90%, 0.5 to 80%, 0.75 to 70%, 1.0 to 50%, 1.5 to 25%, or 2.0 to 15% by weight, with respect to the total solvent extraction composition.

In another embodiment, a purified biosurfactant may be added in combination with an acceptable carrier, in that the biosurfactant may be presented at concentrations of 0.001 to 50% (v/v), preferably, 0.01 to 20% (v/v), more preferably, 0.02 to 5% (v/v).

In some embodiments, the biosurfactant can be included in the composition at, for example, 0.01 to 100,000 ppm, 0.05 to 10,000 ppm, 0.1 to 1,000 ppm, 0.5 to 750 ppm, 1.0 to 500 ppm, 2.0 to 250 ppm, or 3.0 to 100 ppm, with respect to the amount of liquid being treated.

In certain embodiments, the chemical surfactant of the solvent extraction composition is a detergent, wetting agent, emulsifier, foaming agent, and/or dispersant. In some embodiments, the chemical surfactant can be included in the composition at 0.01 to 99.9%, 0.1 to 90%, 0.5 to 80%, 0.75 to 70%, 1.0 to 50%, 1.5 to 25%, or 2.0 to 15% by weight, with respect to the total solvent extraction composition.

The solvent extraction composition can further comprise other additives such as, for example, carriers, other microbe-based compositions, additional biosurfactants, enzymes, catalysts, solvents, salts, buffers, emulsifying agents, lubricants, solubility controlling agents, preservatives, stabilizers, ultra-violet light resistant agents, viscosity modifiers, preservatives, tracking agents, and other microbes and other ingredients specific for an intended use.

### Methods of Solvent Extraction

In certain embodiments, the subject invention provides a method for using solvent extraction to recover metals, minerals, elements, or other compounds of interest from various sources, including, for example, mining sites and industrial sites.

In certain embodiments, the subject invention provides a method for solvent extraction of ores from mines. The method comprises adding the subject compositions to the ore, including, for example, ore tailings or a slurry of ore, and recovering a metal, mineral, or element from the ore. With the use of solvent extraction methods, the metals, minerals, or elements can reach a higher concentration when extracted. In preferred embodiments, the ores are low-grade ores, in which the ores comprise less than about 50%, about 40%, about 35%, about 30%, or about 25% of the substance of interest (e.g., metal, mineral, compound or element being mined), with the remainder comprising gangue.

In certain embodiments, the mining site can be a coal mine, iron ore mine (e.g., taconite), copper mine, copper-nickel mine, tin mine, nickel mine, gold mine, silver mine, molybdenum mine, aluminum mine (e.g., bauxite mine, kyanite mine), lead-zinc mine, tungsten mine, phosphate mine, potash mine, mica mine, bentonite mine, uranium mine, vanadium mine, thorium mine, gallium mine, and borax mine, or zinc mine. In certain embodiments, the slurry of ore or ore tailings from a copper mine and/or a nickel mine comprises silver, gold, platinum, selenium, tellurium, or any combination thereof. The mine can be an underground mine, surface mine, placer mine or in situ mine.

In certain embodiments, methods of recovering toxic compounds are provided according to the subject methods by contacting the solvent extraction compounds to various ores, tailings, or other solutions containing the metal, mineral, or element or interest. In certain embodiments, a variety of toxic compounds can be derived from mining activities. In certain embodiments, methods of removing said toxic compounds are provided according to the subject methods by contacting the solvent extraction compounds to various liquids (e.g., liquids produced during smelting and/or refining) containing the toxic substances contained within aqueous streams, piping, pumps, water storage areas, or other aquatic environments. The toxic compounds can include, for example, cyanide, sulfur-bearing minerals, soluble iron, and heavy metals, such as, for example, molybdenum, tungsten, cadmium, chromium, manganese, nickel, arsenic, and vanadium.

In certain embodiments, a liquid can be pumped or otherwise added to the geological formation containing the element, mineral, metal, or other material of interest before the mineral, compound, or other material of interest is extracted. In certain embodiments, the subject compositions and methods can be used to concentrate and/or purify the sought metal, element, mineral, or other compound of interest.

In certain embodiments, the subject compositions and methods can be used to extract a metal, element, mineral, or other compound of interest from a mining or industrial site by applying the composition to a solution containing the metal, element, mineral, or other compound of interest at the site.

The solvent extraction composition can be applied to a solution containing the element, mineral, metal, or other compound of interest and, optionally, mixed by adding, pouring, shaking or combining. In certain embodiments, the solution and solvent extraction composition are mixed using a mechanical shaker.

In certain embodiments, the time period in which the solvent extraction composition can be contacted and/or mixed to a liquid containing the element, mineral, metal, or other compound of interest is for about 1 second to about 1 year, about 1 minute to about 1 year, about 1 minute to about 6 months, about 1 minute to about 1 month, about 1 minute to about 1 week, about 1 minute to about 48 hours, about 30 minutes to 40 hours, or preferably about 1 hour to about 24 hours. In certain embodiments, the methods comprise applying a liquid or solid form of the solvent extraction composition to the liquid for the period of time in which liquid containing the metal, element, mineral, or other compound of interest is being produced or until the amount of metal, element, mineral, or other compound of interest has been recovered is determined to be satisfactory, which can be readily determined by one skilled in the art.

In certain embodiments, the amount of the solvent extraction composition applied is about 0.00001 to 15%, about 0.00001 to 10%, about 0.0001 to 5%, about 0.001 to 3%, about 0.01%, or about 1 vol % based on an amount of liquid that is treated.

In certain embodiments, the methods of the subject invention result in at least a 25% increase in recovery of metal, element, mineral, or other compound of interest, preferably at least a 50% increase, after one treatment. In certain embodiments, the liquid can be treated multiple times to further increase the amount of recovered metals, elements, minerals, or other compounds of interest.

In certain embodiments, the solvent extraction composition according to the subject invention is effective due to amphiphiles-mediated separation of minerals, metals, elements, or other substances of interest from other dissolved or suspended components. In some embodiments, the sophorolipid or other biosurfactant serves as a vehicle for facilitating solvent extraction of minerals, metals, or elements. For example, in some embodiments, a sophorolipid will form a micelle containing a mineral, metal, or element, wherein the micelle is less than 1 mm, 100 μm, 50 μm, 20 μm, 10 μm, 1 μm, 100 nm, less than 50 nm, less than 25 nm, less than 15 nm or less than 10 nm in size. The small size and amphiphilic properties of the micelle allow for enhanced sequestration of the minerals, metals, elements so that greater recovery of minerals, metals, or elements can occur, allowing for a more efficient solvent extraction process to occur.

In certain embodiments, the solvent extraction compositions can be used in methods of processing ores, ore slurries, or other substances obtained via mining. In certain embodiments, the solvent extraction compositions can be used for solvent extraction after grinding, tailing filling, or any combination thereof.

In certain embodiments, the solvent extraction compositions can be used in beneficiation processes, particularly in low-grade ores containing low concentrations of the element, mineral, metal, or other substance of interest, such as, for example, copper, nickel, cobalt, or uranium. In order to extract the element, mineral, metal, or compound of interest, it can be necessary to crush and grind the ore and preconcentrate or separate the element or substance of interest from the ore by flotation or gravity separation (i.e., settling).

In certain embodiments, the solvent extraction compositions can be used in methods of leaching or as alternatives to methods of leaching, such as, for example, gold cyanidation. The process of extraction by leaching includes leaching (e.g., cyanide leaching), washing and filtering of leaching pulp, extraction of the metal from the leaching solution or pulp, and smelting of finished products. In certain embodiments, the solvent extraction compositions can be used instead of cyanide in order to recover gold from gold-bearing ore.

In certain embodiments, the present invention provides a process for recovering metals, minerals, compounds, or other substances of interest from an aqueous solution containing metals, minerals, elements, or other substances of interest by contacting the aqueous solution with an organic solution including a biosurfactant and an organic solvent, thereby extracting at least part of the metals, minerals, compounds, or other substances of interest from the aqueous phase to the organic phase; and separating the metal, mineral, or element from the aqueous phase, thereby recovering the metal, mineral, or element.

The processes according to the invention can be applied to any metal, element, mineral, or other compound of interest containing stream. It is advantageously applied to a metal, element, mineral, or other compound of interest containing stream resulting from an existing leaching operation where a metal, element, mineral, or other compound of interest is present in solution. In such embodiments, the metal, element, mineral, or other compound of interest can be recovered without downstream impact on the leaching operation or other solvent extraction operations. Additionally, a metal, element, mineral, or other compound of interest can be economically recovered without further mining costs since it is already present in the solution. In certain embodiments, a metal, element, mineral, or other compound of interest concentration in the leach solutions may be increased by acidifying existing heaps/dumps/tails which contain the metal, element, mineral, or other compound of interest. Other sources of a metal, element, mineral, or other compound of interest can also be used and an additional leaching step might then be necessary in those cases. In such embodiments, this additional leach solution can be added to the existing leach solution and processed prior to return to the primary leach inventory.

Accordingly, in certain embodiments of the present invention, different acidic aqueous solutions may be used as the aqueous feed solution, such as leach solutions from existing solvent extraction operations, i.e. copper solvent extraction operations, scrub liquors from acid plants/smelting operations, leach solutions from the processing of flue dusts, filter cakes, metal oxide ores, reprocessing of spent catalysts, or other waste streams containing metals, elements, minerals, or other substances of interests such as, but not limited to, lubricant wastes. More than one source of aqueous solution containing metal can be used.

In one embodiment, the metal containing aqueous feed solution can be acidified (i.e., leached) prior to going to the extraction step in order to limit loading other impurities. While it is common practice in current solvent extraction processes to add an acid to the leach solution (after solvent extraction) to enhance metal dissolution, the subject invention provides adding the acid to the stream of an existing solvent extraction operation prior to, during, and/or after extracting the target metal, mineral, or element in order to enhance selectivity and recovery, and before the leach solution is returned to the primary metal extraction process. The solution containing the metal, element, mineral, or other compound of interest can have a pH of less than about 6, less than about 4, less than about 2.5, or less than about 1.

In certain embodiments, the solvent extraction composition according to the subject invention is effective due to improving phase transfer times (i.e., the transfer of the substance of interest from the aqueous phase to the organic phase), reducing crud formation, particularly during settling of the aqueous and organic phases, and/or protecting against extractant losses due to nitration and oxidation.

Advantageously, in certain embodiments, the solvent extraction composition according to the subject invention provides enhanced or increased efficiency of recovering metals, minerals, compounds, or other substances of interest with limited negative environmental impacts. Additionally, the methods of the subject invention do not require complicated equipment or high energy consumption, and the production of the solvent extraction composition can be performed on site, including, for example, at a mine or at an industrial site. In certain embodiments, the subject solvent extraction composition can result in a decreased use of chemical surfactants, synthetic solvent extraction agents, or other potentially harmful chemicals used for solvent extraction.

### Production of Microbe-Based Products

In certain embodiments, the subject invention provides methods for cultivation of microorganisms and production of microbial metabolites and/or other by-products of microbial growth. The subject invention further utilizes cultivation processes that are suitable for cultivation of microorganisms and production of microbial metabolites on a desired scale. These cultivation processes include, but are not limited to, submerged cultivation/fermentation, solid state fermentation (SSF), and modifications, hybrids and/or combinations thereof.

The microorganisms can be, for example, bacteria, yeast and/or fungi. These microorganisms may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In certain embodiments, the microbes are capable of producing amphiphilic molecules, enzymes, proteins and/or biopolymers. Microbial biosurfactants, in particular, are produced by a variety of microorganisms such as bacteria, fungi, and yeasts, including, for example, Agrobacterium spp. (e.g., A. radiobacter); Arthrobacter spp.; Aspergillus spp.; Aureobasidium spp. (e.g., A. pullulans); Azotobacter (e.g., A. vinelandii, A. chroococcum); Azospirillum spp. (e.g., A. brasiliensis); Bacillus spp. (e.g., B. subtilis, B. amyloliquefaciens, B. pumillus, B. cereus, B. licheniformis, B. firmus, B. laterosporus, B. megaterium); Blakeslea; Candida spp. (e.g., C. albicans, C. rugosa, C. tropicalis, C. lipolytica, C. torulopsis); Clostridium (e.g., C. butyricum, C. tyrobutyricum, C. acetobutyricum, and C. beijerinckii); Campylobacter spp.; Cornybacterium spp.; Cryptococcus spp.; Debaryomyces spp. (e.g., D. hansenii); Entomophthora spp.; Flavobacterium spp.; Gordonia spp.; Hansenula spp.; Hanseniaspora spp. (e.g., H. uvarum); Issatchenkia spp; Kluyveromyces spp.; Meyerozyma spp. (e.g., M. guilliermondii); Mortierella spp.; Mycorrhiza spp.; Mycobacterium spp.; Nocardia spp.; Pichia spp. (e.g., P. anomala, P. guilliermondii, P. occidentalis, P. kudriavzevii); Phycomyces spp.; Phythium spp.; Pseudomonas spp. (e.g., P. aeruginosa, P. chlororaphis, P. putida, P. florescens, P. fragi, P. syringae); Pseudozyma spp. (e.g., P. aphidis); Ralslonia spp. (e.g., R. eulropha); Rhodococcus spp. (e.g., R. erythropolis); Rhodospirillum spp. (e.g., R. rubrum); Rhizobium spp.; Rhizopus spp.; Saccharomyces spp. (e.g., S. cerevisiae, S. boulardii sequela, S. torula); Sphingomonas spp. (e.g., S. paucimobilis); Starmerella spp. (e.g., S. bombicola); Thraustochytrium spp.; Torulopsis spp.; Ustilago spp. (e.g., U. maydis); Wickerhamomyces spp. (e.g., W. anomalus); Williopsis spp.; and/or Zygosaccharomyces spp. (e.g., Z. bailii).

In preferred embodiments, microorganism is a Starmerella spp. yeast and/or Candida spp. yeast, e.g., Starmerella (Candida) bombicola, Candida apicola, Candida batistae, Candida floricola, Candida riodocensis, Candida stellate and/or Candida kuoi. In a specific embodiment, the microorganism is Starmerella bombicola, e.g., strain ATCC 22214.

As used herein “fermentation” refers to cultivation or growth of cells under controlled conditions. The growth could be aerobic or anaerobic. In preferred embodiments, the microorganisms are grown using SSF and/or modified versions thereof.

In one embodiment, the subject invention provides materials and methods for the production of biomass (e.g., viable cellular material), extracellular metabolites (e.g., small molecules and excreted proteins), residual nutrients and/or intracellular components (e.g., enzymes and other proteins).

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, humidity, microbial density and/or metabolite concentration.

In a further embodiment, the vessel may also be able to monitor the growth of microorganisms inside the vessel (e.g., measurement of cell number and growth phases). Alternatively, a daily sample may be taken from the vessel and subjected to enumeration by techniques known in the art, such as dilution plating technique. Dilution plating is a simple technique used to estimate the number of organisms in a sample. The technique can also provide an index by which different environments or treatments can be compared.

In one embodiment, the method includes supplementing the cultivation with a nitrogen source. The nitrogen source can be, for example, potassium nitrate, ammonium nitrate ammonium sulfate, ammonium phosphate, ammonia, urea, and/or ammonium chloride. These nitrogen sources may be used independently or in a combination of two or more.

The method can provide oxygenation to the growing culture. One embodiment utilizes slow motion of air to remove low-oxygen containing air and introduce oxygenated air. In the case of submerged fermentation, the oxygenated air may be ambient air supplemented daily through mechanisms including impellers for mechanical agitation of liquid, and air spargers for supplying bubbles of gas to liquid for dissolution of oxygen into the liquid.

The method can further comprise supplementing the cultivation with a carbon source. The carbon source is typically a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, propanol, butanol, pentanol, hexanol, isobutanol, and/or glycerol; fats and oils such as soybean oil, canola oil, rice bran oil, olive oil, corn oil, sesame oil, and/or linseed oil; etc. These carbon sources may be used independently or in a combination of two or more.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, and microelements can be included, for example, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, sodium chloride, calcium carbonate, and/or sodium carbonate. These inorganic salts may be used independently or in a combination of two or more.

In some embodiments, the method for cultivation may further comprise adding additional acids and/or antimicrobials in the medium before, and/or during the cultivation process. Antimicrobial agents or antibiotics are used for protecting the culture against contamination.

Additionally, antifoaming agents may also be added to prevent the formation and/or accumulation of foam during submerged cultivation.

The pH of the mixture should be suitable for the microorganism of interest. Buffers, and pH regulators, such as carbonates and phosphates, may be used to stabilize pH near a preferred value. When metal ions are present in high concentrations, use of a chelating agent in the medium may be necessary.

The microbes can be grown in planktonic form or as biofilm. In the case of biofilm, the vessel may have within it a substrate upon which the microbes can be grown in a biofilm state. The system may also have, for example, the capacity to apply stimuli (such as shear stress) that encourages and/or improves the biofilm growth characteristics.

In one embodiment, the method for cultivation of microorganisms is carried out at about 5° to about 100° C., preferably, 15 to 60° C., more preferably, 25 to 50° C. In a further embodiment, the cultivation may be carried out continuously at a constant temperature. In another embodiment, the cultivation may be subject to changing temperatures.

In one embodiment, the equipment used in the method and cultivation process is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of low water activity and low pH may be exploited to control undesirable bacterial growth.

In one embodiment, the subject invention further provides a method for producing microbial metabolites such as, for example, biosurfactants, enzymes, proteins, ethanol, lactic acid, beta-glucan, peptides, metabolic intermediates, polyunsaturated fatty acid, and lipids, by cultivating a microbe strain of the subject invention under conditions appropriate for growth and metabolite production; and, optionally, purifying the metabolite. The metabolite content produced by the method can be, for example, at least 20%, 30%, 40%, 50%, 60%, 70%, 80%, or 90%.

The microbial growth by-product produced by microorganisms of interest may be retained in the microorganisms or secreted into the growth medium. The medium may contain compounds that stabilize the activity of microbial growth by-product.

The biomass content of the fermentation medium may be, for example, from 5 g/l to 180 g/l or more, or from 10 g/l to 150 g/l.

The cell concentration may be, for example, at least 1×10⁶ to 1×10¹², 1×10⁷ to 1×10¹¹, 1×10⁸ to 1×10¹⁰, or 1×10⁹ CFU/ml.

The method and equipment for cultivation of microorganisms and production of the microbial by-products can be performed in a batch, a quasi-continuous process, or a continuous process.

In one embodiment, all of the microbial cultivation composition is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the fermentation product is removed at any one time. In this embodiment, biomass with viable cells, spores, conidia, hyphae and/or mycelia remains in the vessel as an inoculant for a new cultivation batch. The composition that is removed can be a cell-free medium or contain cells, spores, or other reproductive propagules, and/or a combination of thereof. In this manner, a quasi-continuous system is created.

Advantageously, the method does not require complicated equipment or high energy consumption. The microorganisms of interest can be cultivated at small or large scale on site and utilized, even being still-mixed with their media.

In certain embodiments, the subject invention provides a “microbe-based composition,” meaning a composition that comprises components that were produced as the result of the growth of microorganisms or other cell cultures. Thus, the microbe-based composition may comprise the microbes themselves and/or by-products of microbial growth. The microbes may be in a vegetative state, in spore form, in mycelial form, in any other form of propagule, or a mixture of these. The microbes may be planktonic or in a biofilm form, or a mixture of both. The by-products of growth may be, for example, metabolites, cell membrane components, expressed proteins, and/or other cellular components. The microbes may be intact or lysed. The microbes may be present in or removed from the composition. The microbes can be present, with broth in which they were grown, in the microbe-based composition. The cells may be present at, for example, a concentration of at least 1×10³, 1×10⁴, 1×10⁵, 1×10⁶, 1×10⁷, 1×10⁸, 1×10⁹, 1×10¹⁰, 1×10¹¹, 1×10¹², 1×10¹³ or more CFU per milliliter of the composition.

The subject invention further provides “microbe-based products,” which are products that are to be applied in practice to achieve a desired result. The microbe-based product can be simply a microbe-based composition harvested from the microbe cultivation process. Alternatively, the microbe-based product may comprise further ingredients that have been added. These additional ingredients can include, for example, stabilizers, acids, buffers, carriers, such as water, salt solutions, or any other appropriate carrier, added nutrients to support further microbial growth, non-nutrient growth enhancers, and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

One microbe-based product of the subject invention is simply the fermentation medium containing the microorganisms and/or the microbial metabolites produced by the microorganisms and/or any residual nutrients. The product of fermentation may be used directly without extraction or purification. If desired, extraction and purification can be easily achieved using standard extraction and/or purification methods or techniques described in the literature.

The microorganisms in the microbe-based products may be in an active or inactive form, or in the form of vegetative cells, reproductive spores, conidia, mycelia, hyphae, or any other form of microbial propagule. The microbe-based products may also contain a combination of any of these forms of a microorganism.

In one embodiment, different strains of microbe are grown separately and then mixed together to produce the microbe-based product. The microbes can, optionally, be blended with the medium in which they are grown and dried prior to mixing.

The microbe-based products may be used without further stabilization, preservation, and storage. Advantageously, direct usage of these microbe-based products preserves a high viability of the microorganisms, reduces the possibility of contamination from foreign agents and undesirable microorganisms, and maintains the activity of the by-products of microbial growth.

Upon harvesting the microbe-based composition from the growth vessels, further components can be added as the harvested product is placed into containers or otherwise transported for use. The additives can be, for example, buffers, carriers, other microbe-based compositions produced at the same or different facility, viscosity modifiers, preservatives, nutrients for microbe growth, surfactants, emulsifying agents, lubricants, solubility controlling agents, tracking agents, solvents, biocides, antibiotics, pH adjusting agents, chelators, stabilizers, ultra-violet light resistant agents, other microbes and other suitable additives that are customarily used for such preparations.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C. On the other hand, a biosurfactant composition can typically be stored at ambient temperatures.

1. A method of solvent extraction, the method comprising:
a) contacting a solvent extraction composition comprising an extractant and an organic solvent to a liquid containing a metal, mineral, or element; and
b) recovering the metal, mineral, or element water from the liquid,
wherein the extractant is a biosurfactant.

2. The method of claim 1, wherein the recovering comprises settling the mixture of the solvent extraction composition the liquid containing the metal, mineral, or element.

3. The method of claim 2, wherein at least two distinct phases form during the settling, and wherein a first phase is an organic phase containing the metal, mineral, or element and a second phase is an aqueous phase.

4. The method of claim 1, wherein the contacting comprises mixing the solvent extraction composition and the liquid for at least about 1 min to about 24 hours.

5. The method of claim 1, wherein the liquid is ore tailings or a slurry of ore.

6. The method of claim 5, wherein the slurry of ore or ore tailings is from a coal mine, iron ore mine, copper mine, cobalt mine, copper-nickel mine, tin mine, nickel mine, gold mine, silver mine, molybdenum mine, aluminum mine, lead-zinc mine, tungsten mine, phosphate mine, potash mine, mica mine, bentonite mine, bentonite mine, uranium mine, vanadium mine, thorium mine, gallium mine, borax mine, or zinc mine.

7. The method of claim 6, wherein the aluminum mine is a kyanite mine or a bauxite mine.

8. The method of claim 6, wherein the slurry of ore or ore tailings from the copper mine and/or the nickel mine comprises silver, gold, platinum, selenium, and/or tellurium.

9. The method of claim 1, wherein the solvent extraction composition further comprises a chemical surfactant, extractant, acid, organic solvent, oxime, modified aldoxime, amine, phosphate, phosphine, chelating agent, diluent, polymer, or water.

10. (canceled)

11. The method of claim 1, wherein the biosurfactant is a glycolipid and/or an inactive yeast culture comprising a glycolipid.

12. The method of claim 11, wherein the inactive yeast culture is a Starmerella sp. and/or a Candida sp. yeast.

13. The method of claim 11, wherein the method comprises the use of a glycolipid that is a sophorolipid, mannosylerythritol lipid, trehalose lipid, or rhamnolipid.

14. The method of claim 13, wherein the sophorolipid is a linear sophorolipid or a lactonic sophorolipid.

15. The method of claim 1, wherein the liquid further comprises a toxic substance or gangue.

16. The method of claim 15, wherein the toxic substance is cyanide, a sulfur-bearing mineral, soluble iron, molybdenum, tungsten, cadmium, chromium, manganese, nickel, arsenic, or vanadium.

17. The method of claim 1, wherein the solvent extraction comprises recovering the element, mineral, or metal from the liquid by one or a combination of the following:
a) sequestering the element, mineral, or metal from an aqueous phase into an organic phase;
b) forming an organic-soluble salt with anions; or
c) reacting with cations; and
d) settling the element, mineral, or metal.

18. A solvent extraction composition comprising a glycolipid and/or an inactive yeast culture comprising a glycolipid and a traditional solvent extraction component, wherein the inactive yeast culture is a Starmerella sp., wherein the glycolipid is selected from sophorolipids, mannosylerythritol lipids, trehalose lipids, and rhamnolipids, and wherein the traditional solvent extraction component is selected from the following:
a) chemical surfactant;
b) polymer;
c) water;
d) extractant;
e) acid;
f) organic solvent;
g) oxime;
h) modified aldoxime;
i) amine;
j) phosphate;
k) phosphine;
l) chelating agent;
m) diluent; and
n) polymer.

19-22. (canceled)
